(19) United States
(12) Patent Application Publication
(10) Pub. No.: US 2003/0219005 A1
(43) Pub. Date: Nov. 27, 2003

(54) Method for controlling exchanges of frames between a control unit and at least one radio station, and control unit for implementing the method

(75) Inventors: Olivier Isnard, Viroflay Cedex (FR); Frederic Ratovelomanana, Paris (FR); Jean-Marie Calmel, Versailles (FR); Robert W. Dijkerman, Ottawa (CA); Shedman Tam, Ottawa (CA); Quanying Peng, Ottawa (CA); Jian G. Zhao, Kanata (CA)

Correspondence Address: PIPER RUDNICK, P. O. BOX 64807, CHICAGO, IL, 60664-0807, US

(73) Assignee: NORTEL NETWORKS LIMITED

(21) Appl. No.: 10/423,285

(22) Filed: Apr. 25, 2003

(30) Foreign Application Priority Data
Apr. 30, 2002 (FR) FR 02 05454

(51) Int. Cl. H04J 3/06

(52) U.S. Cl. 370/350; 370/509

(57) ABSTRACT

Each radio station (2) has a receiving window associated with each frame, positioned according to a time marker inserted in the said frame by a control unit (1). The frames include data frames (5), in which the time marker is inserted for synchronization with a radio terminal (4), and signalling frames. Each radio station indicates a data frame received outside the associated receiving window, and responds to a signalling frame by returning to the control unit a synchronization parameter representing a time of arrival of the said signalling frame. In a period of transmission of successive data frames: signalling frames are transmitted to each radio station simultaneously; returned synchronization parameters are processed; and times of transmission of successive data frames are controlled according to the processed parameters.

### BACKGROUND OF THE INVENTION

The present invention relates to techniques for controlling exchanges of frames in telecommunications systems and in particular to the control of times of transmission and reception of these frames.

A particular application of the invention is in the synchronization of transport channels in UMTS (Universal Mobile Telecommunication System) type third generation cellular networks standardized by the organization 3GPP (3rd Generation Partnership Project).

The invention is described hereinafter in its application to a UMTS network in Frequency Division Duplex (FDD) mode, and FIG. 1 shows the architecture of such a network.

The mobile service switches 10, belonging to a Core Network (CN), are linked to one or more fixed networks 11 and, by means of an interface called Iu, to control units 12, or RNCs (Radio Network Controllers). Each RNC 12 is linked to one or more radio stations 13 by means of an interface called Iub. The radio stations 13, distributed over the network coverage area, can communicate by radio with mobile terminals 14, 14a and 14b, called UEs (User Equipment). The radio stations can be grouped together to form nodes called “Nodes B”. Some RNCs 12 can additionally communicate with each other by means of an interface called Iur. The RNCs and the radio stations form an access network called UTRAN (UMTS Terrestrial Radio Access Network).

The UTRAN includes elements from layers 1 and 2 of the ISO model with a view to providing the links required on the radio interface (called Uu), and a Radio Resource Control (RRC) stage 15A belonging to layer 3, as described in the technical specification 3G TS 25.301, “Radio Interface Protocol Architecture”, version 4.2.0 published in December 2001 by the 3GPP. Viewed from the upper layers, the UTRAN acts simply as a relay between the UE and the CN.

FIG. 2 shows the RRC stages 15A, 15B and the stages of the lower layers that belong to the UTRAN and to a US. On each side, layer 2 is subdivided into a Radio Link Control (RLC) stage 16A, 16B and a Medium Access Control (MAC) stage 17A, 17B. Layer 1 includes a coding and multiplexing stage 18A, 18B. A radio stage 19A, 19B provides for the transmission of radio signals based on symbol trains supplied by stage 18A, 18B, and provides for the reception of signals in the other direction.

There are various ways of adapting the protocol architecture according to FIG. 2 to the UTRAN hardware architecture according to FIG. 1, and in general various structures can be adopted according to the channel types (see section 11.2 of the technical specification 3G TS 25.401, “UTRAN Overall Description”, version 4.2.0 published in September 2001 by the 3GPP). The RRC, RLC and MAC stages are in the RNC 12. Layer 1 is for example in the Node B. Part of this layer may however be in the RNC 12.

Layers 1 and 2 are each controlled by the RRC sub-layer, the characteristics of which are described in the technical specification 3G TS 25.331, “RRC Protocol Specification”, version 4.1.0 published in June 2001 by the 3GPP. The RRC stage 15A, 15B supervises the radio interface. It additionally handles flows to be transmitted to the remote station according to a “control plane”, as opposed to the “user plane” which corresponds to the handling of user data coming from layer 3. UMTS in FDD mode supports a macrodiversity technique which involves anticipating that a UE can communicate simultaneously with separate radio stations in an active set such that, in the downlink direction, the UE receives the same information several times and that, in the uplink direction, the radio signal transmitted by the UE is picked up by the radio station to form various estimations which are then combined in the UTRAN. Macrodiversity results in a receive gain which improves the performance of the system owing to the combination of different observations of the same item of information. It also enables Soft Handovers (SHOs) to be achieved as the UE moves.

In macrodiversity, branching of transport channels for multiple transmission from the UTRAN or the UE and the combination of these transport channels in receive mode are operations for which a selection and combination module belonging to layer 1 is responsible. This module is at the interface with the MAC sub-layer, and it is located in the RNC serving the UE. If the radio stations involved depend on different RNCs communicating over the Iur interface, one of these RNCs acts as SRNC and the other as DRNC.

When several RNCs are involved in a communication with a UE, there is generally one Serving RNC (SRNC), in which the layer-2-based modules (RLC and MAC) are located, and at least one Drift RNC (DRNC) to which a radio station is linked, and with which radio station the UE is in radio communication. Suitable protocols provide the exchanges between these RNCs over the Iur interface, for example ATM (Asynchronous Transfer Mode) and AAL2 (ATM Adaptation Layer No. 2).

These same protocols can also be employed on the Sub interface for exchanges between a Node B and its RNC. Above the ATM and AAL2 layers, a Frame Protocol (FP) is used in the user plane to enable the SRNC to communicate with the Node B or Nodes B involved in a communication with a given UE.

This FP protocol is described in the technical specifications 3G TS 25.427, “UTRAN Iub/Iur Interface User Plane Protocol for DCH Data Streams”, and 3G TS 25.435, “UTRAN Tub Interface User Plane Protocols for Common Transport Channel Data Streams”, versions 4.3.0, published in December 2001 by the 3GPP. In particular, it provides signalling frames allowing transport channels to be synchronized in the manner described in section 7 of the technical specification 3G TS 25.402, “Synchronization in UTRAN Stage 2”, version 4.3.0, published in December 2001 by the 3GPP.

The objective of this transport channel synchronization is to obtain a layer 2 common frame numbering between the UTRAN and the UE, achieved using an 8-bit Connection Frame Number (CFN), managed by layer 2 for each Transport Block Set (TBS) exchanged with the UE by incrementing it by one unit every 10 ms.

This CFN is not transmitted over the air interface, but it is added to the frames exchanged over the Iub interface. The physical layer maps it to a frame numbering kept up-to-date for each cell, defined by a System Frame Number (SFN) coded on 12 bits. The Node B increments this SFN at each new 10 ms radio frame and broadcasts it over the common control channels of the cell.

For a given TBS and a given cell, the offset between the CFN and the SFN is determined before the radio link between the Node B and the UE concerned is set up, in terms of an offset expressed by an integer number of frames (Frame Offset). When the radio emission is started for the TBS, this offset is zero: the CFN is initialized at the SFN. (modulo 256) of the first frame used for transmitting the TBS. Before a radio link is added in macrodiversity mode, the UE measures the offset between the current CFN and the SEN broadcast by the new cell and reports this to the SRNC. From this information, the SRNC deduces the relevant “Frame Offset” parameter for the new cell and informs the Node B of it in order that the Node B takes account of the offset between the CFN and SFN counters.

In the downlink direction, when a data frame is to be transmitted to the UE, the SRNC anticipates its transmission with respect to the corresponding CFN to take account of the time to route up to the Node B and of the processing time required by the Node B, particularly in the coding and multiplexing stage 18A. The standard specifies a receiving window for each FP frame (DCH-FP PDU) that the SNRC addresses to a Node B, and this window is defined in reference to a TOA (Time Of Arrival) axis directed in the opposite direction to time with an origin at the reference point TOA=0. This window is defined by the following parameters:

T_{proc} equal to the minimum time, depending on the equipment, required by the Node B to process a frame before the Node B can start to transmit on the air interface;

TOAWS (Time Of Arrival Window Startpoint) determining the width of the receiving window. A frame received with a TOA between 0 and TOAWS is considered as received normally (“OK” in FIG. 3 which shows the receiving window for the CFN 152 frame). A frame received with a TOA that is greater than TOAWS is considered as received early (“Early” in FIG. 3);

TOAWE (Time Of Arrival window Endpoint) determining the position of the receiving window, that is the position of the reference point TOA=0 which is earlier than T_{proc}+TOAWE at the time-instant corresponding to the start of the period of the frame numbered CFN (having taken account of the Frame Offset). When it is greater than 0, this TOAWE parameter enables frames received late but which can still be processed by the Node B (−TOAWE<TOA<0, “Late” in FIG. 3) and frames received too late and destroyed by the Node B (TOA←TOAWE, “Too Late” in FIG. 3) to be distinguished.

When the Node B receives a data frame outside the corresponding window, it reports this to the RNC in an FP protocol TAD (Timing Adjustment) frame, which contains the CFN number of the data frame concerned and the value of the TOA with which the data frame was received (see sections 5.2 and 6.3.3.1 of the aforementioned specification 3G TS 25.427). The RNC can use this information to correct the time-instant at which it transmits subsequent frames to the Node B.

During periods in which there are no data frames to be transmitted, the RNC sends “DL SYNC” signalling frames to the Node B, each frame containing the CFN in relation to which the said frame should be received. The Node B responds immediately by returning a “UL SYNC” frame indicating this CFN and the TOA value for the arrival of this frame. This mechanism is used to prevent the window from drifting without the RNC being notified by TAD frames (see section 7.2 of the aforementioned specification 3G TS 25.402 and sections 5.3, 6.3.3.2 and 6.3.3.3 of the aforementioned specification 3G TS 25.427).

In a macrodiversity situation, each FP frame of a given CFN is transmitted only once by the SRNC. The differences in speed of Iub or Iur/Iub links require the correct transmission time-instant to be determined by the SRNC. For the Nodes B with which the Iub or Iur/Iub links are fast, high TOA values mean that the buffers in the Nodes B may lack capacity. Conversely, for the Nodes B with which the Iub or Iur/Iub links are slow, low or negative TOA values run the risk of resulting in data loss. Each addition or removal of a cell in the active set for a given TBS results in a modification of these constraints.

Furthermore, although the framework proposed by the 3GPP can be used to establish bases for defining transport channel synchronization via the Iub interface in the downlink direction, nothing is specified in this regard for the uplink direction Nevertheless, problems encountered in the downlink direction are also present in the latter case.

In the uplink direction, each Node B transmits data frames to its serving RNC (SRNC). However, there is no timing provision on the Nodes B to delay or anticipate transmission of uplink frames so that these frames can be transmitted with gaps between them in the time domain. At the SRNC, frames received with an identical CFN number from the various Nodes B are combined regularly upon expiry of a TTI (Transmission Time Interval) timer If certain uplink frames are received by the SRNC after this timer expires, they will be lost and not taken into account in the combination process. Conversely, frames received too early by the SRNC, that is, beyond the maximum capacity of the SRNC buffers, will not be able to be held in memory to be taken into account in the frame combination process.

An object of the present invention is to propose a method enabling a control unit such as an RNC to define optimum time-instants to perform operations required for frames exchanged with one or more radio stations.

Another object is to arrive at a satisfactory compromise between a minimum rate of loss of frames transmitted and a minimum waiting time for the transmission of these frames.

Yet another aim is to propose a mechanism for reporting information and analysis of this information to a control unit such as an RNC to improve the sequencing of operations to be performed on the frames, whether this be in the downlink direction or in the uplink direction.

### SUMMARY OF THE INVENTION

The invention thus proposes a method for controlling the transmission of frames from a control unit to at least one radio station, in which method each radio station has a respective receiving window associated with each frame, positioned in time according to a time marker inserted in the said frame by the control unit. The frames include data frames, in which the time marker is inserted by the control unit for synchronization with a radio terminal to which each radio station transmits data of the said data frames, and signalling frames. Each radio station is arranged for indicating to the control unit a data frame received outside the associated receiving window, and for responding to a signalling frame by returning to the control unit a synchronization parameter representing a time of arrival of the said signalling frame with respect to the associated receiving window. The method includes the following steps executed by the control unit in a period of transmission of successive data frames:

transmission of signalling frames to each radio station;

processing of the returned synchronization parameters; and

controlling the times of transmission of successive data frames according to the processed parameters.

The transmission of signalling frames can be periodic, such that synchronization information is regularly received at the RNC. Moreover, this regularity can be variable. It can in particular depend on the quantity of information already available at the RNC, for example following a large number of TAD frame transmissions.

The processing of returned synchronization parameters can include a comparison at predetermined time-instants. The comparison can be made on estimators based on the synchronization parameters returned as sliding averages of the times of arrival of the last frames received at the RNC.

Depending on the result of this comparison, an adjustment value can be calculated by the control unit. It will be used to extend or reduce the times of transmission from the RNC for the next data frames. It shall preferably be calculated so that the next frames are received, with high probability, in the associated receiving window, without significant risk of loss, and this will be done for each radio station.

The adjustment value can in particular be chosen to aim for a precise time-instant in the receiving window. For example, this time-instant can be located at the time of arrival window endpoint for the radio station having the slowest link with the control unit.

According to another aspect, the invention proposes a method for controlling the reception and combination of frames at a control unit, the frames being transmitted from at least one radio station, in which method the control unit has a receiving window associated with each frame, positioned in time according to a time marker inserted in the said frame by each radio station. The frames include data frames, in which the time marker is inserted by each radio station for synchronization with a radio terminal transmitting data of the said data frames. The control unit is arranged for detecting a data frame received outside the associated receiving window, and for determining a time of arrival of a data frame with respect to the associated receiving window. The control unit is arranged for combining data frames received from at least some of the radio stations and containing the same time marker, at a date of expiry of a respective timer, and date of expiry is positioned in time according to the associated receiving window. The method includes the following steps executed by the control unit in a period of reception of successive data frames:

processing of the determined times of arrival;

controlling the date of expiry of the timer according to the processed times of arrival.

The control unit can adapt its times of arrival of frames coming from the various radio stations, such that their loss rate is reduced. It can do this by modifying the value of the abovementioned timer and, when this timer expires, by combining the set of data received from the various radio stations. As long as the timer has not expired, it can receive numbered frames in order to then take account of them in its combination process for frames having the same number.

An adjustment value for the date of expiry of the timer can be chosen to aim for a precise time-instant, within the appropriate receiving window, for the reception of frames by the control unit. For example, this time-instant can be located at the time of arrival window endpoint for frames transmitted by the radio station having the slowest link with the control unit. The adjustment value can also, as a preference, be evaluated on the basis of an estimation, for example an average, of several time of arrival indications.

Furthermore, the invention proposes control units to implement the methods described above.

### BRIEF DESCRIPTION OF THE DRAWINGS

FIG. 1, already referred to, is a schematic diagram of the architecture of a UMTS system;

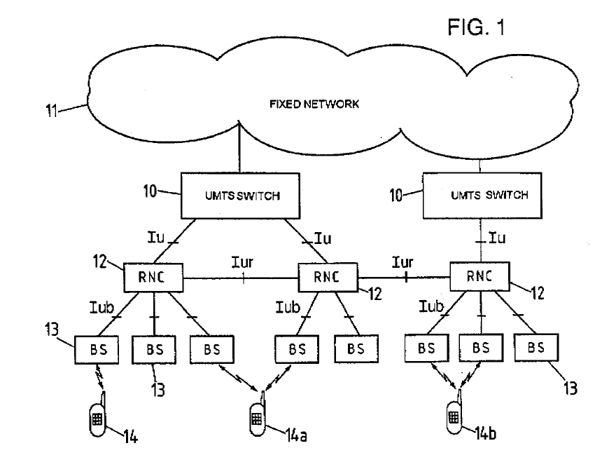

FIG. 2, already referred to, is a schematic diagram representing the protocol layers that are common to the UTRAN and the UE;

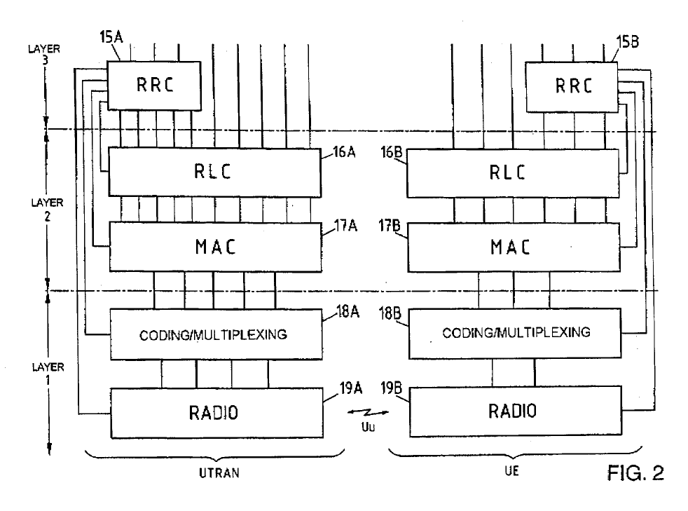

FIG. 3, already referred to, is a schematic representation of windows participating in the synchronization of the Iub interface, as standardized in the UMTS system by the 3GPP;

FIG. 4 is a schematic representation of a mechanism for controlling transmission of downlink frames according to the invention, as applied to the Iub interface;

FIG. 5 is a diagram showing the steps for calculating an adjustment value in an example embodiment in downlink mode;

FIG. 6 is a schematic representation of a mechanism for controlling the reception of uplink frames according to the invention, as applied to the Iub interface;

FIG. 7 is a diagram showing steps for calculating an adjustment value in an example embodiment in uplink mode.

### DESCRIPTION OF PREFERRED EMBODIMENTS

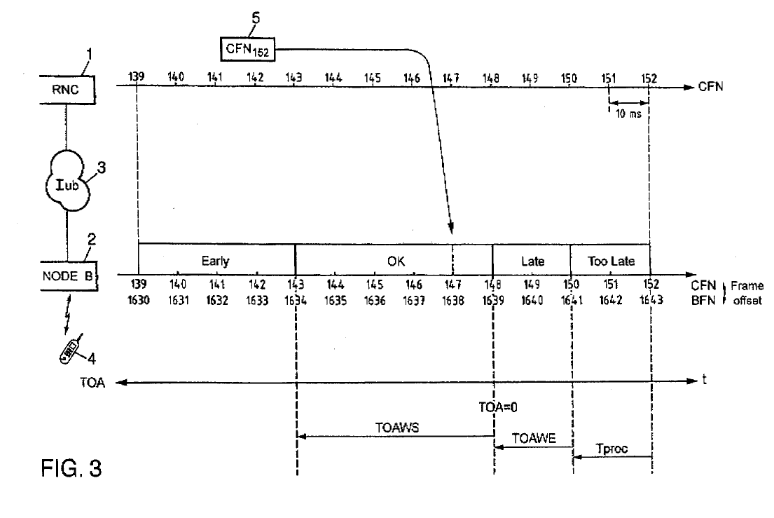

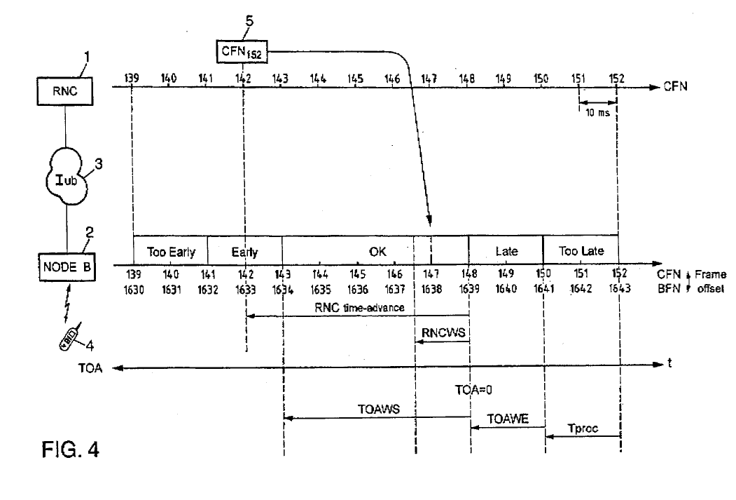

Returning to the non-limiting case of the UMTS Iub interface, FIG. 4 shows, in a representation analogous to that of FIG. 3, the main elements participating in the synchronization of the Iub interface according to the invention. In particular, the various receiving zones standardized by the 3GPP are used. According to the invention, the “Early” window specified by the 3GPP has been divided into two parts, “Too early” and “Early”, as was the case for the standardized “Late” and “Too late” windows. The separation between these two windows (CFN=141 in FIG. 4) is related to the maximum size of buffers of the Nodes B2. This means that a frame 5 arriving at a Node B2 between the “Early” and “Too late” windows, that is between CFN=141 and CFN=152, can usually be stored in a buffer of the Node B2. If the frame arrives too early, typically in the “Too early” window, the storage capacity of the Node B2 is not sufficient to be able to store the frame for a long enough time until its retransmission. Thus, such a frame will not be able to be retransmitted to a terminal 4. It should however be noted that the window sizes used in the example illustrated by FIG. 4 are simple non-limiting examples. In particular, the windows used can have sizes that are not multiples of 10 ms.

As described previously, uplink frames containing synchronization parameters representing a time of arrival of received downlink frames are sent to the RNC 1, either upon its request (“UL SYNC” signalling frames in response to “DL SYNC”), or after a Node B2 receives a data frame outside the receiving window marked “OK”. This transfer of information therefore provides pertinent elements which the RNC can make use of as a basis for a decision to control its times of transmission for future frames. According to the invention, this transfer of information can be systemized, so that the RNC 1 constantly has up-to-date information about the times of arrival, including during periods of silence. To this end, the RNC 1 can send successive “DL SYNC” signalling frames, for example periodically, to each Node B2. The Nodes B2 respond to each “DL SYNC” control frame by a “UL SYNC” signalling frame containing a synchronization parameter representing a Time Of Arrival (TOA) of the preceding “DL SYNC” frame, with the CFN number which it contained. Thus, even in the absence of any reception of TAD frame from the RNC 1, the RNC 1 has regularly updated information about the times of arrival of frames which it transmits to the Nodes B2 and therefore about the durations of transmission of these frames. Advantageously, the period of sending of “DL SYNC” frames by the RNC 1 depends on the quantity of information already available about the times of transmission between the RNC 1 and each Node B2. For example, if, over an observation period corresponding to for example a period of transmission of successive data frames, an Iub interface gives rise to a large number of transfers in the form of TAD frames, from a Node B2, the sending period of “DL SYNC” frames can be reduced by the RNC 1. Conversely, if few TAD frames are sent by a Node B2 to the RNC 1, the latter can decide to increase the sending period of “DL SYNC” frames intended for the Node B concerned. Moreover, the sending period of “DL SYNC” frames can vary over time according to conditions or particular events, such as the presence or absence of macrodiversity, the addition or removal of a Node B in the active set in communication with the terminal 4, or the load rate on the transport layer of the Iub interface.

It should be noted that, since the transmission of a “DL SYNC” frame by the RNC 1 to a Node B2 usually results in a response from the Node B in the form of a “UL SYNC” frame, the lack of a response from a Node B2 can lead to diagnosing a failure on the Iub interface beyond a simple physical link failure (in particular, an AAL2 transport level failure).

After transmission by a Node B2 of a synchronization parameter representing a time of arrival of a “UL SYNC” frame in response to a “DL SYNC” frame, the RNC 1 stores the received value in a table. The parameter concerned can for example be a TOA value as described earlier. In the storage table of the RNC 1, this value is associated with the CFN number included in the corresponding “DL SYNC” frame and at the Node B in question. Thus, when several Nodes B2 are in communication with the terminal 4 in macrodiversity mode, the RNC 1 stores in its table the set of TOA values received for a given CFN and for each Node B2.

At a given time-instant, the RNC 1 sends the data frames to the Nodes B2 with a certain time-advance with respect to the time reference TOA=0. Thus, the time-advance used by the RNC 1 for the frame 5 of FIG. 4 is 60 ms, corresponding to six time intervals of 10 ms between the time of transmission of the frame by the RNC (CFN=142) and the reference TOA=0 (CFN=148 for the frame in question). It is assumed here that the periodicity of the frames on the Iub interface is 10 ms (it could also have a greater value, multiple of 10 ms). Without adjusting the time-advance, the RNC 1 will send the next frame, including the number CFN=153, to the Nodes B2 with the same time-advance as for the frame 5 (60 ms). To take account of the variations of times of transmission on the Iub interfaces 3 and any additions and/or removals of Nodes B2 in the active set of the Nodes B in communication with the terminal 4, it is however preferable to adjust the time-advance. This automatic control of times of transmission for the next frames can be achieved by comparing values stored in the table of the RNC 1 with predetermined reference values.

The reference values taken into account include values of parameters standardized by the 3GPP, that is TOAWS and TOAWE described in the first part. Furthermore, a new parameter is introduced in the invention: RNCWS (RNC Window Size). It corresponds to the receiving point to be aimed for by the RNC 1 within the “OK” receiving window, for a Node B2. RNCWS can have a fixed or variable value. It may for example depend on the type of service requested by the user of the terminal 4. A low, even negative, RNCWS may thus be used for a real-time service, that is requiring very rapid transmission to the detriment of a potentially high loss rate. The RNCWS can also take into account the size of buffers of the Nodes B2, such that its value is limited for very reduced queues. The RNC 1 will be able to store a table setting out a correspondence between RNCWS values and various criteria (service requested, buffer size, etc.), so as to initialize the RNCWS at an appropriate value when setting up the link or service for example.

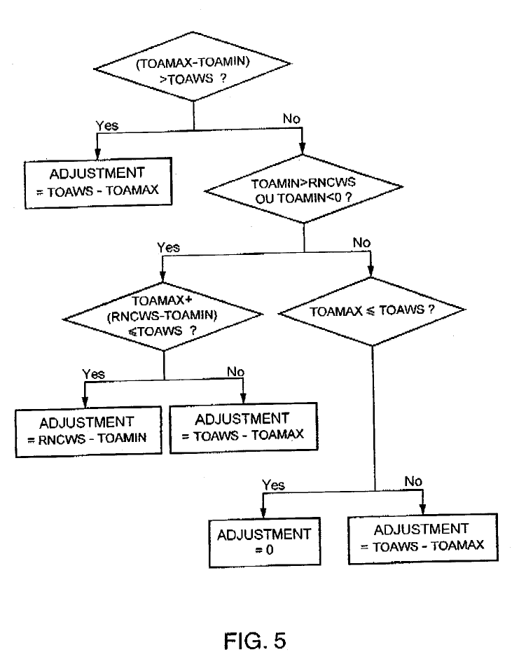

FIG. 5 shows a diagram proposing an adjustment value calculation according to an advantageous embodiment of the invention. It is based on an estimation of values stored by the RNC 1, since, as described earlier, the RNC stores successive (that is, for successive CFNs) TOA values for each Node B2 in communication with the terminal 4. Then, for each Node B, it performs an estimation of times of arrival, which is a function of at least one stored TOA value. For example, the estimation may be a sliding average of the last N stored TOA values, where N is a non-zero natural integer. The RNC thus obtains an average of the TOAs for each Node B2, updated for example at each new reception, by the RNC, of a time of arrival transmitted by the said Node B. At a given time-instant, typically upon reception of a new set of TOAs from the various Nodes B2, the RNC 1 selects the minimum value TOAMIN and the maximum value TOAMAX from the estimations obtained. TOAMIN corresponds to the slowest Iub interface (that is, having the longest transmission time) and TOAMAX to the fastest Iub interface. For the case in which the terminal 4 would be in communication only with a single Node B2, the values TOAMAX and TOAMIN would be equal and the sequence of calculation steps below could still be applied. In one embodiment, the RNCWS value may be chosen to be low with respect to the TOAWS value, such that a frame received at the time-instant corresponding to RNCWS is received at the “OK” time of arrival window endpoint.

In the example of FIG. 5, the first step is to compare the maximum difference in “speed” of the Iub interfaces, TOAMAX−TOAMIN, with the TOAWS value. By this comparison, it can be determined if at least one of the two Iub interfaces considered exhibits a frame reception outside the “OK” receiving window. If this is the case, the adjustment value is set at the difference TOAWS−TOAMAX, which means bringing back TOAMAX to the TOAWS value, or even imposing a frame reception at the start of the “OK” receiving window for the fastest link. In this way, the slower Iub interfaces 3 will lead to frames being received within the “OK” receiving window, while others, such as the slowest interface, will result in late receptions of frames and perhaps losses of frames in the case of reception in the “Too late” window.

If the difference TOAMAX−TOAMIN is less than or equal to TOAWS, the TOAMIN value is of interest. If TOAMIN is greater than RNCWS or negative and if TOAMAX+(RNCWS−TOAMIN) is less than or equal to TOAWS, this means that TOAMAX would be less than TOAWS and therefore within the “OK” receiving window if TOAMIN was brought back to the RNCWS value. In this case, the adjustment value of the RNC time-advance is set to RNCWS-TOAMIN such that, for the slowest Iub interface 3, frames are once again received at the time-instant corresponding to RNCWS (CFN=147 in FIG. 4, for the frame 5 numbered CFN=152). Thus, all the Iub interfaces 3 result in frames being received within the desired receiving window (“OK” window). If TOAMIN is greater than RNCWS or negative, but TOAMAX+(RNCWS−TOAMIN) is greater than TOAWS, the adjustment value is set at TOAWS−TOAMAX, that is reception for the fastest Iub interface is brought back to the start of the “OK” receiving window. Thus all the Iub interfaces 3 result in frames being received within the appropriate “OK” window, even though the slowest interface is close to a frame-loss situation, that is at the end of the “OK” window (between RNCWS and TOA=0).

If the difference TOAMAX−TOAMIN is less than or equal to TOAWS and TOAMIN is less than or equal to RNCWS while being positive (that is at the end of the “OK” window), the TOAMAX value comes into play. If TOAMAX is less than or equal to TOAWS, that is within the “OK” receiving window, all the Iub interfaces including the slowest and fastest, based on calculated averages, result in frames being received within the window reserved for this purpose (“OK” window). In this case, no adjustment is needed. Otherwise, it is advisable to make TOAMAX fail within the “OK” window, since this will not make TOAMIN fall outside this window. This is why, in this case, an adjustment of TOAWS−TOAMAX is chosen, which returns TOAMAX to the start of the “OK” window.

For the transmission of the next frame (frame inserting CFN=153), the RNC 1 will re-evaluate the anticipated time of transmission (for example, CFN=143, that is an RNC time-advance of 10*10=100 ms) by translating it according to the adjustment value calculated by the method above. Thus, if the adjustment value obtained is −10 ms, the new RNC time-advance will be 100−10=90 ms and the corresponding transmission will be carried out by the RNC at the time-instant corresponding to CFN=144, in the example of FIG. 4.

In a number of cases, the calculated adjustment value will have a value less than 10 ms, in terms of absolute value, so that the transmission of frames will generally take place between two CFN numbers at the RNC 1. Nevertheless, the adjustment value may turn out to be 10 ms, or more. In that case, the RNC time-advance is increased such that the next frame is transmitted at a time-instant corresponding to a lower CFN than anticipated, that is CFN=142 in our example.

Furthermore, it is to be noted that the TOA values returned by the Nodes B2 and stored by the RNC 1 must be considered according to different adjustments carried out, in order to be able to compared. Indeed, a time-advance for the transmission of a frame by the RNC 1, for example, accordingly modifies the times of arrival on each Node B2. This is why it is advisable to update, in the RNC's storage tables, the last reported times of arrival, at each adjustment of the RNC time-advance, by adding the calculated adjustment value to them. The values TOAMIN and TOAMAX are then evaluated from homogeneous data, with a common time reference.

If an adjustment value has just been evaluated by the RNC 1 based on the last N times of arrival reported by each Node B2 of the active set, and if a new report of time of arrival takes place after this evaluation, in response to the reception of a signalling frame transmitted by the RNC 1 before the adjustment calculation, this new reported time will have been obtained in reference to the former time system (TOA value not translated according to the new adjustment value). This is for example the case for a control frame sent by a Node B2 to the RNC 1 with a CFN value earlier to that corresponding to the calculation of the adjustment in progress. To prevent any confusion and to have consistent temporal data, the RNC 1 can choose to ignore the new indication of time of arrived reported by the Node S. This will then not be stored in the RNC's table and will therefore not be taken into account in the estimations of times of arrival for the Node B concerned. In an advantageous alternative, the RNC 1 compares the CFN sent by the Node B2 in the control frame with the CFN for which the calculation of the adjustment value is in progress and, if the control frame results from the reception of a frame prior to the calculation of the adjustment, the RNC nevertheless stores the returned time of arrival but translating it from the newly calculated adjustment value. The information reported by the Node B is thus made to conform with the new reference system, related to the RNC anticipation. This same update before storage of the time of arrival can be applied to any Node B of the active set considered.

During the adjustment calculation steps above, communication is taking place between the various Nodes B2 and the terminal 4. When the radio link is set up between the RNC 1 and the Nodes B2 of the active set, that is before the start of the communication with the terminal 4, no parameter value is available yet. To this end, the parameters can be initialized as follows: the value 0 is assigned to the first CFN considered and the value of the first TOA received at the RNC is assigned to the TOAMAX and TOAMIN parameters. Later, when an uplink frame is received at the RNC 1, the latter checks the CFN value that it contains and checks that it correctly matches a CFN value for which a downlink frame has been transmitted and for which the RNC 1 waits for a synchronization parameter representing a time of arrival. If this is the case, the TOA value reported in the uplink frame is stored by the RNC 1. Otherwise, the frame is ignored.

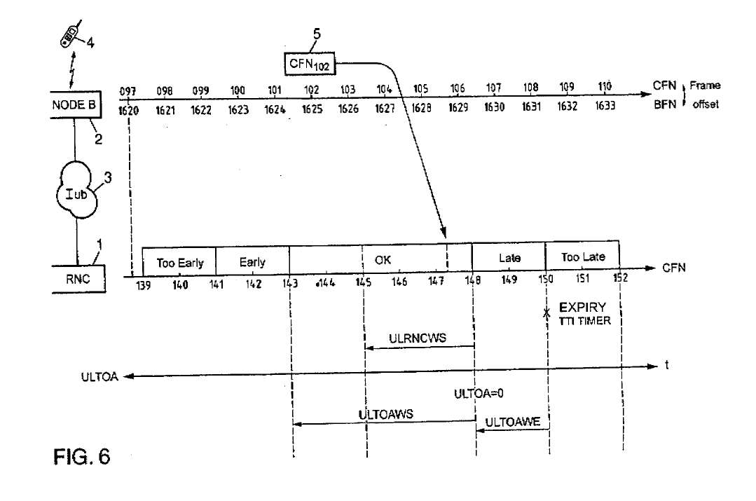

FIG. 6 illustrates a second aspect of the invention which applies to an uplink transmission, that is to a transmission of uplink frames, from the Nodes B2 of an active set in communication with a terminal 4, to an RNC 1. As revealed previously in the downlink case, each Node B2 keeps a knowledge of the difference of the time axis which it manages (BFN) with that managed by the RNC 1 (CFN) and offsets this difference (Frame Offset) to send frames to the RNC containing a CFN indication corresponding to a date of transmission of the frames. As far as the RNC is concerned, it therefore simply requires to read the CFN values received in the uplink data frames from the various Nodes B2 and to combine among them those frames containing the same CFN. This combination takes place when the TTI timer, introduced earlier, expires. The TTI timer is initiated after each combining of uplink frames and ends at a date of expiry that can vary slightly from one frame to another (time-instant corresponding to CFN=150, seen from the RNC, for the frame 5 in FIG. 6).

As FIG. 6 shows, the invention defines in the uplink direction the same types of receiving windows as in the downlink direction, except that the latter are applied at the RNC 1. The time reference (ULTOA=0) varies at each expiry of the TTI timer. Furthermore, as previously, values ULTOAWS, size of the “OK” receiving window at the RNC 1, and ULTOAWE, size of the “Late” window according to the “OK” window, are defined. If a frame 5 containing CFN=102 is transmitted by a Node B2, and received by the RNC 1 in the “Too early” time window, as shown in FIG. 6 (CFNs 139 to 141), it will not be taken into account by the RNC 1 since the RNC 1 does not have buffers with sufficient capacity to store it until the frames of CFN=102 are combined, that is when the TTI timer expires, which happens at the end of the “Late” window (CFN=150). Conversely, if the frame 5 is received by the RNC 1 after CFN=150, that is within a “Too late” receiving window, frames of CFN=102 have already been combined and the frame 5 is therefore lost. The RNC 1 can additionally detect if a frame 5 is received outside the “OK” receiving window, in one of the “Early” (CFNs 141 to 143 in FIG. 6) or “Late” (CFNs 148 to 150 in FIG. 6) time windows. The invention also introduces a ULRNCWS (UpLink RNCWS) parameter, the value of which is less than ULTOAWS, and which reflects a time of arrival at the RNC 1 well suited to the Iub interface 3, limiting the frame loss rate, in particular if the Nodes B are added or removed from the active set in communication with the terminal 4. ULRNCWS can be chosen at the start of communication, for example from a table that is predefined and stored in the RNC 1 and which takes into account various criteria such as the service requested.

Unlike at the RNC 1 in the downlink case described previously, the Nodes B2 do not control their time of transmission but transmit uplink data frames, containing a CFN time marker, to the RNC as soon as the data frames are available. It is therefore the RNC's responsibility to modify its times for combining frames received to limit the frame loss rate. To do this, it modifies the TTI timer expiry dates anticipated for the next frame combination processes, such that a maximum number of frames received from the Nodes B2 are received before the timer expires, preferably within the “OK” receiving window and if possible at time-instants close to ULRNCWS, at least for the slowest Iub 3 links, that is those with the highest transmission times. This control of the TTI timer expiry date therefore corresponds to an offset of this date with respect to the CFN scale. It is accompanied by a translation of receiving windows in time for the next uplink data frame receiving periods.

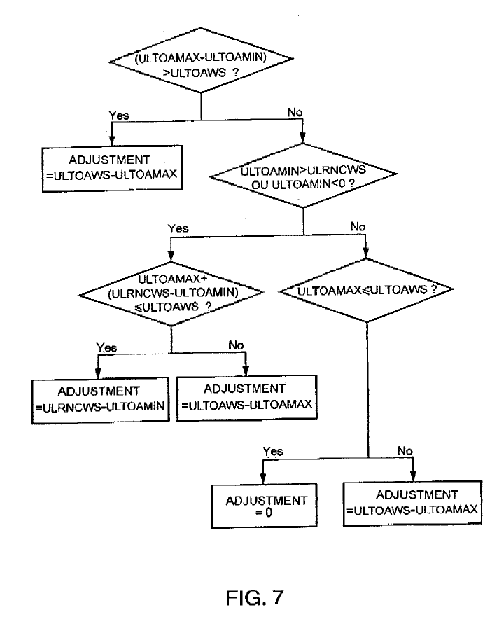

To carry out the control, a process of the same type as described for the downlink direction can be implemented. Times of arrival are established by the RNC 1 when an uplink data frame with a given CFN number (CFN=102 for example for the frame 5) is received. The RNC stores the corresponding values (ULTOA) for each Node B2 of the active set in communication with the terminal 4. Estimations are then made based on stored values. For example, the RNC calculates, for each Node B, a sliding average on the last N consecutive values of ULTOA corresponding to frames having the same CFN, where N is a non-zero natural integer. At each time-instant, the RNC can determine a maximum value ULTOAMAX and a minimum value ULTOAMIN, which can be equal when a single Node B is involved. FIG. 7 shows an example of a process for calculating an adjustment value according to the values ULTOAMAX and ULTOAMIN determined and according to their comparison with the parameters ULTOAWS and ULRNCWS introduced above. The different steps of the process can be summarized as follows:

if ULTOAMAX−ULTOAMIN is greater than ULTOAWS, the adjustment value is set at ULTOAWS−ULTOAMAX;

if ULTOAMAX−ULTOAMIN is less than or equal to ULTOAWS,

if ULTOAMIN is greater than ULRNCWS or if ULTOAMIN is negative,

if ULTOAMAX+(ULRNCWS−ULTOAMIN) is less than or equal to ULTOAWS, the adjustment value is set at ULRNCWS−ULTOAMIN,

if ULTOAMAX+(ULRNCWS−ULTOAMIN) is greater than ULTOAWS, the adjustment value is set at ULTOAWS−ULTOAMAX;

if ULTOAMIN is positive or zero and less than or equal to ULRNCWS,

if ULTOAMAX is less than or equal to ULTOAWS, the adjustment value is zero,

if ULTOAMAX is greater than ULTOAWS, the adjustment value is set at ULTOAWS−ULTOAMAX.

The adjustment value obtained is then added, after frame combination, to that of the TTI timer to modify the TTI timer expiry date in anticipation of the next frame receiving period. This control of the TTI timer expiry date is used to advance or, on the contrary, to delay the times of arrival at the RNC 1, for the next receiving period, so that the RNC is prepared to receive a maximum number of frames before the TTI timer expires, without extending too much the delay for combining frames of the same CFN. Consequently, the RNC 1 translates its receiving windows such that a maximum number of frames are received preferably in the “OK” receiving window during the next uplink frame receiving periods.

As for the downlink direction, values of times of arrival of uplink frames stored at the RNC 1 must be updated to prevent oscillation of the system. The update consists of a translation of these values according to the adjustment value, after adjustment of the TTI timer expiry date to take account of this change.

1. Method for controlling the transmission of frames from a control unit to at least one radio station, in which method each radio station has a respective receiving window associated with each frame, positioned in time according to a time marker inserted in the said frame by the control unit, in which method the frames include data frames, in which data frames the time marker is inserted by the control unit for synchronization with a radio terminal to which each radio station transmits data of the said data frames, and signalling frames, and in which method each radio station is arranged for indicating to the control unit a data frame received outside the associated receiving window, and for responding to a signalling frame by returning to the control unit a synchronization parameter representing a time of arrival of the said signalling frame with respect to the associated receiving window, the method including the following steps executed by the control unit in a period of transmission of successive data frames:
transmission of signalling frames to each radio station simultaneously;
processing of the returned synchronization parameters; and
controlling the times of transmission of successive data frames according to the processed parameters.

2. Method according to claim 1, in which the transmission of signalling frames to each radio station is periodic.

3. Method according to claim 2, in which the transmission of signalling frames to each radio station has a variable periodicity in time.

4. Method according to claim 1, in which the signalling frames are transmitted to each radio station in a proportion that depends on a number of frames returned to the control unit by at least some of the radio stations to indicate a data frame received outside the associated receiving window over a period of transmission of successive data frames.

5. Method according to claim 1, in which a transport link between the control unit and a radio station is determined as failing when the said radio station does not return to the control unit a synchronization parameter representing a time of arrival, in response to signalling frames.

6. Method according to claim 1, in which the said processing of synchronization parameters returned in response to a signalling frame includes a comparison of the said synchronization parameters at predetermined time-instants with respect to an associated time of arrival window endpoint.

7. Method according to claim 6, in which the said predetermined time-instants are start points of respectively the receiving window (TOAWS) and a receiving sub-window (RNCWS) positioned at the time of arrival window endpoint.

8. Method according to claim 7, in which RNCWS is set beforehand according to a service type requested by the said radio terminal.

9. Method according to claim 7, in which the processing of synchronization parameters returned in response to a signalling frame includes a determination, at the control unit, of an estimation of times of arrival, for each radio station, based on the last N synchronization parameters returned, where N is an integer that is greater than or equal to 1, and a determination among the said estimations of a maximum value TOAMX corresponding to the earliest time-instant estimation and a minimum value TOAMIN corresponding to the latest time-instant estimation, the two values TOAMIN and TOAMAX being able to be equal, in which method an adjustment value is determined, such as:
if TOAMAX−TOAMIN is greater than TOAWS, the adjustment value is set at TOAWS−TOAMAX;
if TOAMAX−TOAMIN is less than or equal to TOAWS,
if TOAMIN is greater than RNCWS or if TOAMIN is negative,
if TOAMAX+(RNCWS−TOAMIN) is less than or equal to TOAWS, the adjustment value is set at RNCWS−TOAMIN,
if TOAMAX+(RNCWS−TOAMIN) is greater than TOAWS, the adjustment value is set at TOAWS−TOAMAX;
if TOAMIN is positive or zero and less than or equal to RNCWS,
if TOAMAX is less than or equal to TOAWS, the adjustment value is zero,
if TOAMAX is greater than TOAWS, the adjustment value is set at TOAWS−TOAMAX;
and in which method the means for controlling times of transmission of successive data frames includes a translation according to the said determined adjustment value.

10. Method according to claim 9, in which the estimation of times of arrival for each radio station is a sliding average performed on the last N synchronization parameters returned by the said radio station.

11. Method according to claim 1, in which, after processing, the synchronization parameters returned to the control unit are modified, according to the same controlling means as for the times of transmission of successive data frames.

12. Method according to claim 1, in which, after processing of the synchronization parameters, a synchronization parameter returned to the control unit in response to a signalling frame transmitted by the control unit before the processing of the synchronization parameters is ignored.

13. Method according to claim 1, in which, after processing of the synchronization parameters returned to the control unit, a synchronization parameter returned to the control unit in response to a signalling frame transmitted by the control unit before processing of the synchronization parameters is modified, the said modification including the same controlling means as for the times of transmission of successive data frames.

14. Method for controlling the reception and combination of frames at a control unit, the frames being transmitted from at least one radio station, in which method the control unit has a receiving window associated with each frame, positioned in time according to a time marker inserted in the said frame by each radio station, in which method the frames include data frames, in which data frames the time marker is inserted by each radio station for synchronization with a radio terminal transmitting data of the said data frames, in which method the control unit is arranged for detecting a data frame received outside the associated receiving window, and for determining a time of arrival of a data frame with respect to the associated receiving window, and in which method the control unit is arranged for combining data frames received from at least some of the radio stations and containing the same time marker, at a date of expiry of a respective timer, and this, date of expiry is positioned in time according to the associated receiving window, the method including the following steps executed by the control unit in a period of reception of successive data frames:
processing of the determined times of arrival;
controlling the date of expiry of the timer according to the processed times of arrival.

15. Method according to claim 14, in which the said processing of the determined times of arrival includes a comparison of the said determined times of arrival of a data frame at predetermined time-instants with an associated time of arrival window endpoint.

16. Method according to claim 15, in which the said predetermined time-instants are start points respectively of the receiving window (ULTOAWS) and of a receiving sub-window (ULRNCWS) positioned at the time of arrival window endpoint.

17. Method according to claim 16, in which ULRNCWS is set beforehand according to a service type requested by the said radio terminal.

18. Method according to claim 16, in which the processing of times of arrival determined for a data frame includes a determination, at the control unit, of an estimation of times of arrival, for each radio station, of the last N determined times of arrival, where N is an integer greater than or equal to 1, and a determination, among the said estimations, of a maximum value ULTOAMAX corresponding to the earliest time-instant estimation and a minimum value ULTOAMIN corresponding to the latest time-instant estimation, the two values ULTOAMIN and ULTOAMAX being able to be equal, in which method an adjustment value is determined such as:
if ULTOAMAX−ULTOAMIN is greater than ULTOAWS, the adjustment value is set at ULTOAWS−ULTOAMAX;
if ULTOAMAX−ULTOAMIN is less than or equal to ULTOAWS,
if ULTOAMIN is greater than ULRNCWS or if ULTOAMIN is negative,
if ULTOAMAX+(ULRNCWS−ULTOAMIN) is less than or equal to ULTOAWS, the adjustment value is set at ULRNCWS−ULTOAMIN,
if ULTOAMAX+(ULRNCWS−ULTOAMIN) is greater than ULTOAWS, the adjustment value is set at ULTOAWS−ULTOAMAX;
if ULTOAMIN is positive or zero and less than or equal to ULRNCWS,
if ULTOAMAX is less than or equal to ULTOAWS, the adjustment value is zero,
if ULTOAMAX is greater than ULTOAWS, the adjustment value is set at ULTOAWS−ULTOAMAX;
and in which method the means for controlling the date of expiry of the timer according to the processed times of arrival includes a translation according to the said determined adjustment value.

19. Method according to claim 18, in which the estimation of times of arrival for a radio station is a sliding average performed on the last N times of arrival determined for the said radio station.

20. Method according to claim 14, in which, after processing, the times of arrival of data frames received at the control unit before processing are modified, according to the same controlling means as for the date of expiry of the timer.

21. Control unit including means of transmission of frames to at least one radio station and means of insertion of a time marker in each frame, each radio station having a respective receiving window associated with each frame, positioned in time according to the said time marker, the transmitted frames including data frames, in which data frames the time marker is inserted for synchronization with a radio terminal to which each radio station transmits the data of the said data frames, and signalling frames, the receiving unit additionally including means for receiving from each radio station an indication of reception of a data frame outside the associated receiving window and means of receiving a synchronization parameter returned by a radio station in response to a signalling frame, the said synchronization parameter representing a time of arrival of the said signalling frame with respect to the associated receiving window, the control unit including:
means for transmitting signalling frames to each radio station simultaneously, in a period of transmission of successive data frames;
means for processing the synchronization parameters returned; and
means for controlling the times of transmission of successive data frames according to processed parameters.

22. Control unit according to claim 21, in which the transmission of signalling frames to each radio station is periodic.

23. Control unit according to claim 22, in which the transmission of signalling frames to each radio station has a variable periodicity in time.

24. Control unit according to claim 21, in which the transmission of signalling frames to each radio station is in a proportion that depends on a number of frames returned to the control unit by at least some of the radio stations to indicate a data frame received outside the associated receiving window over a period of transmission of successive data frames.

25. Control unit according to claim 21, in which the means of processing of synchronization parameters returned in response to a signalling frame include a comparison of the said synchronization parameters at predetermined time-instants with respect to an associated time of arrival window endpoint.

26. Control unit according to claim 25, in which the $ said predetermined time-instants are start points of respectively the receiving window (TOAWS) and a receiving sub-window (RNCWS) positioned at the time of arrival window endpoint.

27. Control unit according to claim 26, in which RNCWS is set beforehand according to a service type requested by the said radio terminal.

28. Control unit according to claim 26, in which the means of processing of synchronization parameters returned in response to a signalling frame include a determination of an estimation of times of arrival, for each radio station, based on the last N synchronization parameters returned, where N is an integer that is greater than or equal to 1, and a determination among the said estimations of a maximum value TOAMX corresponding to the earliest time-instant estimation and a minimum value TOAMIN corresponding to the latest time-instant estimation, the two values TOAMIN and TOAMAX being able to be equal, the control unit additionally having means for determining an adjustment value such as:
if TOAMAX−TOAMIN is greater than TOAWS, the adjustment value is set at TOAWS−TOAMAX;
if TOAMAX−TOAMIN is less than or equal to TOAWS,
if TOAMIN is greater than RNCWS or if TOAMIN is negative,
if TOAMAX+(RNCWS−TOAMIN) is less than or equal to TOAWS, the adjustment value is set at RNCWS−TOAMIN,
if TOAMAX+(RNCWS−TOAMIN) is greater than TOAWS, the adjustment value is set at TOAWS−TOAMAX;
if TOAMIN is positive or zero and less than or equal to RNCWS,
if TOAMAX is less than or equal to TOAWS, the adjustment value is zero,
if TOAMAX is greater than TOAWS, the adjustment value is set at TOAWS-TOAMAX;
and in which method the means for controlling the times of transmission of successive data frames include a translation according to the said determined adjustment value.

29. Control unit according to claim 28, in which the estimation of times of arrival for each radio station is a sliding average performed on the last N synchronization parameters returned by the said radio station.

30. Control unit according to claim 21, including means for modifying, after processing, the synchronization parameters returned, according to the same controlling means as for the times of transmission of successive data frames.

31. Control unit according to claim 21, including means for ignoring, after processing of the synchronization parameters, a synchronization parameter returned in response to a signalling frame transmitted before the processing of the synchronization parameters.

32. Control unit according to claim 21, including means for modifying, after processing of the returned synchronization parameters, a synchronization parameter returned to the control unit in response to a signalling frame transmitted by the control unit before processing of the synchronization parameters, the said modification including the same means for controlling as for the times of transmission of successive data frames.

33. Control unit including means for receiving and combining frames, the frames being transmitted from at least one radio station, the control unit having a receiving window associated with each frame, positioned in time according to a time marker inserted in the said frame by each radio station, the frames including data frames, in which data frames the time marker is inserted by each radio station for synchronization with a radio terminal transmitting data of the said data frames, the control unit having means for detecting a data frame received outside the associated receiving window, and for determining a time of arrival of a data frame with respect to the associated receiving window, the control unit additionally including means for combining data frames received from at least some of the radio stations and containing the same time marker, at a date of expiry of a respective timer, positioned in time according to the associated receiving window, the control unit also including:
means for processing the determined times of arrival, in a period of reception of successive data frames;
means for controlling the date of expiry of the timer according to the processed times of arrival.

34. Control unit according to claim 33, in which the means of processing of the determined times of arrival include a comparison of the said determined times of arrival of a data frame at predetermined time-instants with respect to an associated time of arrival window endpoint.

35. Control unit according to claim 34, in which the said predetermined time-instants are start points respectively of the receiving window (ULTOAWS) and of a receiving sub-window (ULRNCWS) positioned at the time of arrival window endpoint.

36. Control unit according to claim 35, in which ULRNCWS is set beforehand according to a service type requested by the said radio terminal.

37. Control unit according to claim 35, in which the means of processing of times of arrival determined for a data frame include a determination of an estimation of times of arrival, for each radio station, of the last N determined times of arrival, where N is an integer greater than or equal to 1, and a determination, among the said estimations, of a maximum value ULTOAMAX corresponding to the earliest time-instant estimation and a minimum value ULTOAMIN corresponding to the latest time-instant estimation, the two values ULTOAMIN and ULTOAMAX being able to be equal, the control unit additionally having means for determining an adjustment value such as:
if ULTOAMAX−ULTOAMIN is greater than ULTOAWS, the adjustment value is set at ULTOAWS−ULTOAMAX;
if ULTOAMAX−ULTOAMIN is less than or equal to ULTOAWS,
if ULTOAMIN is greater than ULRNCWS or if ULTOAMIN is negative,
if ULTOAMAX+(ULRNCWS−ULTOAMIN) is less than or equal to ULTOAWS, the adjustment value is set at ULRNCWS−ULTOAMIN,
if ULTOAMAX+(ULRNCWS−ULTOAMIN) is greater than ULTOAWS, the adjustment value is set at ULTOAWS−ULTOAMAX;
if ULTOAMIN is positive or zero and less than or equal to ULRNCWS,
if ULTOAMAX is less than or equal to ULTOAWS, the adjustment value is zero,
if ULTOAMAX is greater than ULTOAWS, the adjustment value is set at ULTOAWS−ULTOAMAX;
and in which method the means for controlling the date of expiry of the timer according to the processed times of arrival include a translation according to the said determined adjustment value.

38. Control unit according to claim 37, in which the estimation of times of arrival for a radio station is a sliding average performed on the last N times of arrival determined for the said radio station.

39. Control unit according to claim 33, including means for modifying, after processing, the times of arrival of data frames received at the control unit before processing, according to the same controlling means as for the date of expiry of the timer.
